(19) United States
(12) Patent Application Publication
(10) Pub. No.: US 2025/0232754 A1
(43) Pub. Date: Jul. 17, 2025

(54) ELECTRONIC APPARATUS AND CONTROL METHOD THEREOF

(71) Applicant: SAMSUNG ELECTRONICS CO., LTD., Suwon-si (KR)

(72) Inventors: Artur SZUMACZUK, Warszawa (PL); Krzysztof ARENDT, Warszawa (PL); Bartlomiej JASIK, Warszawa (PL); Grzegorz STEFANSKI, Warszawa (PL); Jaemo YANG, Suwon-si (KR); Jakub TKACZUK, Warszawa (PL); Michal SWIATEK, Warszawa (PL); Tomasz MACIAG, Warszawa (PL)

(73) Assignee: SAMSUNG ELECTRONICS CO., LTD., Suwon-si (KR)

(21) Appl. No.: 19/098,577

(22) Filed: Apr. 2, 2025

Related U.S. Application Data
(63) Continuation of application No. PCT/KR2023/013501, filed on Sep. 8, 2023.

(30) Foreign Application Priority Data
Oct. 6, 2022 (KR) 10-2022-0128054

(51) Int. Cl. G10K 11/178; G10L 25/51

(52) U.S. Cl. CPC G10K 11/17823; G10K 11/17873; G10L 25/51; G10K 2210/3012; G10K 2210/3016; G10K 2210/3027; G10K 2210/3033

(57) ABSTRACT

A control method of an electronic apparatus for generating anti-noise for acoustic noise cancellation (ANC) is provided. The method includes obtaining audio data and metadata of the audio data, classifying the audio data into a plurality of audio clusters based on at least one of a feature of the audio data or a feature of the metadata, identifying whether each audio cluster of the plurality of audio clusters is included in a local database corresponding to the location information of a place where the audio data is obtained, based on the at least one of the plurality of the audio clusters being not included in the local database, updating the local database by adding information regarding the audio cluster that is not included in the plurality of noise clusters to information regarding the plurality of noise clusters and generating anti-noise data based on the information regarding the local database which is updated.

### CROSS-REFERENCE TO RELATED APPLICATIONS

This application is a continuation application of International Application No. PCT/KR2023/013501, filed on Sep. 8, 2023, which claims priority to Korean Patent Application No. 10-2022-0128054, filed on Oct. 6, 2022, the disclosures of which are incorporated by reference herein in their entireties.

### BACKGROUND

### 1. Field

The disclosure relates to an electronic apparatus and a control method thereof, and more particularly, to an electronic apparatus that selectively cancels noise surrounding the electronic apparatus while outputting audio, and a control method thereof.

### 2. Description of Related Art

An audio device such as headphones, earphones, or earbuds, may use various noise cancellation technologies. For example, the audio device may acquire audio surrounding the audio device through a microphone connected to a noise cancellation circuit, and cancel noise included in the audio surrounding the audio device, thereby outputting an audio signal having improved quality to a user.

The audio device may use active noise cancellation (ANC) technology, thereby determining a surrounding noise environment and actively canceling the noise. The audio device using the ANC technology may be designed to actively cancel the noise by using the surrounding noise environment, thereby canceling out surrounding noise if the audio signal is provided from the electronic apparatus to the user.

### SUMMARY

According to an aspect of the disclosure, there is provided a control method of an electronic apparatus for generating anti-noise for acoustic noise cancellation (ANC), including: obtaining audio data and metadata of the audio data; classifying the audio data into a plurality of audio clusters based on at least one of a feature of the audio data or a feature of the metadata; identifying whether each audio cluster of the plurality of audio clusters is included in a local database corresponding to the location information of a place where the audio data is obtained; based on the at least one of the plurality of the audio clusters being not included in the local database, updating the local database by adding information regarding the audio cluster that is not included in the local database and generating anti-noise data based on the information regarding the local database which is updated.

The local database comprises a plurality of noise clusters, and the identifying whether each audio cluster of the plurality of audio clusters is included in the local database may include: identifying one audio cluster of the local database as being included in the plurality of noise clusters based on one noise cluster matching the one audio cluster being present among the plurality of noise clusters.

The identifying whether each of the plurality of audio clusters is included in the local database may include: obtaining a similarity value between the one audio cluster and the one noise cluster; and identifying the one noise cluster of the plurality of noise clusters as the one noise cluster matching the one audio cluster based on the similarity value being at least a predetermined value.

The updating the local database by adding of the information regarding the audio cluster may include: obtaining, from an external server, the information regarding the audio cluster that is not included in the local database; and adding the information regarding the audio cluster that is not included in the local database to the information regarding the local database.

The updating the local database by adding of the information regarding the audio cluster may include: obtaining a user input for inputting identification information for the audio cluster that is not included in the local database; and adding the information regarding the audio cluster including the identification information to the information regarding the local database.

The updating the local database by adding of the information regarding the audio cluster may include: providing a sound inquiring whether to add the information regarding the audio cluster to the information regarding the local database; and based on obtaining a user voice for adding the information regarding the audio cluster to the information regarding the local database, obtaining the user input for inputting the identification information for the audio cluster that is not included in the local database.

The generating the anti-noise data may include generating the anti-noise data at a level corresponding to a noise cluster matching the audio cluster for each audio cluster of the plurality of audio clusters included in the local database among the plurality of audio clusters.

The plurality of audio clusters include a first audio cluster and a second audio cluster, and wherein the generating the anti-noise data may include: generating first anti-noise data for the first audio cluster at a first level corresponding to a first noise cluster matching the first audio cluster among the plurality of noise clusters; and generating second anti-noise data for the second audio cluster at a second level corresponding to a second noise cluster matching the second audio cluster among the plurality of noise clusters.

The classifying of the audio data into the plurality of audio clusters may include: obtaining a plurality of audio segments by segmenting the audio data; obtaining a plurality of feature data by extracting features of the plurality of audio segments; and classifying the plurality of audio segments into a plurality of sound clusters based on the plurality of feature data.

The metadata of the audio data may include location information of where the audio data is obtained.

According to an aspect of the disclosure, there is provided an electronic apparatus including: a sensor; a microphone; a speaker; a memory storing at least one instruction and information regarding a local database; and at least one processor connected to the memory, wherein the at least one instruction, when executed by the at least one processor, cause the electronic apparatus to: obtain audio data and metadata of the audio data through the microphone and the sensor; classify the audio data into a plurality of audio clusters based on at least one of a feature of the audio data or a feature of the metadata; identify whether each audio cluster of the plurality of audio clusters is included in the local database corresponding to the location information of a place where the audio data is obtained; and based on the at least one of the plurality of the audio clusters being not included in the local database, update the local database by adding information regarding the audio cluster that is not included in the local database, and generate anti-noise data based on the information regarding the local database which is updated.

The local database comprises a plurality of noise clusters, and the at least one instruction, when executed by the at least one processor, may cause the electronic apparatus to identify one audio cluster of the plurality of audio clusters as being included in the local database based on one noise cluster matching the one audio cluster being present among the plurality of noise clusters.

The at least one instruction, when executed by the at least one processor, may cause the electronic apparatus to: obtain a similarity value between the one audio cluster and the one noise cluster; and identify the one noise cluster as the one noise cluster matching the one audio cluster if the similarity value is a predetermined value or more.

The at least one instruction, when executed by the at least one processor, may cause the electronic apparatus to: obtain, from an external server, the information regarding the audio cluster that is not included in the local database; and add the information regarding the audio cluster that is not included in the local database to the information regarding the local database.

The at least one instruction, when executed by the at least one processor, may cause the electronic apparatus to: obtain a user input for inputting identification information for the audio cluster that is not included in the local database, and add the information regarding the audio cluster including the identification information to the information regarding the local database.

According to an aspect of the disclosure, there is provided a non-transitory computer readable recording medium including instructions that, when executed, performs a method including: obtaining audio data and metadata of the audio data; classifying the audio data into a plurality of audio clusters based on at least one of a feature of the audio data or a feature of the metadata; identifying whether each audio cluster of the plurality of audio clusters is included in a local database corresponding to the location information of a place where the audio data is obtained; and based on the at least one of the plurality of the audio clusters being not included in the local database, updating the local database by adding information regarding the audio cluster that is not included in the local database t and generating anti-noise data based on the information regarding the local database which is updated.

The identifying whether each audio cluster of the plurality of audio clusters is included in the local database may include: identifying one audio cluster of the plurality of audio clusters as being included in the local database based on one noise cluster matching the one audio cluster being present among the plurality of noise clusters.

The identifying whether each of the plurality of audio clusters is included in the local database may include: obtaining a similarity value between the one audio cluster and the one noise cluster; and identifying the one noise cluster of the plurality of noise clusters as the one noise cluster matching the one audio cluster based on the similarity value being at least a predetermined value.

The adding of the information regarding the audio cluster may include: obtaining, from an external server, the information regarding the audio cluster that is not included in the local database; and adding the information regarding the audio cluster that is not included in the local database to the information regarding the local database.

The adding of the information regarding the audio cluster may include: obtaining a user input for inputting identification information for the audio cluster that is not included in the local database; and adding the information regarding the audio cluster including the identification information to the information regarding the local database.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a block diagram illustrating a configuration of an electronic apparatus, according to an embodiment of the disclosure;

FIG. 2 is a flowchart for describing a method of the electronic apparatus for clustering audio data, according to an embodiment of the disclosure;

FIG. 3 is a flowchart illustrating a method of the electronic apparatus for detecting whether an audio cluster is included in a pre-stored noise cluster, according to an embodiment of the disclosure;

FIG. 4 is a flowchart illustrating a method of the electronic apparatus for receiving information regarding the audio cluster from an external server and updating information regarding the noise cluster, according to an embodiment of the disclosure;

FIG. 5 is a flowchart illustrating a method of the electronic apparatus for updating the information regarding the noise cluster on the basis of a user feedback, according to an embodiment of the disclosure;

FIG. 6 is a sequence diagram illustrating a method of the electronic apparatus for updating the information regarding the plurality of noise clusters stored in the external device, according to an embodiment of the disclosure;

FIG. 7 is a flowchart illustrating a method of the electronic apparatus for updating the information regarding the plurality of noise clusters by using the information regarding the audio cluster included in the plurality of noise clusters, according to an embodiment of the disclosure;

FIG. 8 is a flowchart illustrating a method of the electronic apparatus for updating the information regarding the noise cluster stored in a memory of the electronic apparatus, according to an embodiment of the present disclosure;

FIG. 9 is a sequence diagram illustrating a method of the electronic apparatus for updating the information regarding the noise cluster stored in a memory of the external server, according to an embodiment of the disclosure.

FIG. 10 is a flowchart illustrating a control method of an electronic apparatus according to an embodiment of the present disclosure;

FIGS. 11 and 12 are flowcharts illustrating an operation of the electronic apparatus, according to an embodiment of the disclosure; and

FIG. 13 is a flowchart illustrating an operation of the external server, according to an embodiment of the disclosure.

### DETAILED DESCRIPTION

The disclosure may be variously modified and have several embodiments, and embodiments of the disclosure are shown in the drawings and described in detail in the detailed description. However, it should be understood that the scope of the disclosure is not limited to the disclosed embodiments, and includes various modifications, equivalents, and/or alternatives according to the embodiments of the disclosure. Throughout the accompanying drawings, similar components are denoted by similar reference numerals.

In describing the embodiments, omitted is a detailed description of a case where it is decided that the detailed description of the known functions or configurations related to the disclosure may unnecessarily obscure the gist of the disclosure.

In addition, the following embodiments may be modified in several different forms, and the scope of the disclosure are not limited to the following embodiments. Rather, these embodiments are provided to make the disclosure thorough and complete, and completely transfer the disclosure to those skilled in the art.

Terms used in the disclosure are used only to describe the embodiments rather than limiting the scope of the disclosure. A term of a singular number includes its plural number unless explicitly interpreted otherwise in the context.

In the disclosure, the expression “have”, “may have”, “include”, “may include” or the like, indicates the presence of a corresponding feature (for example, a numerical value, a function, an operation, or a component such as a part), and does not exclude the presence of an additional feature.

In the disclosure, an expression “A or B”, “at least one of A and/or B”, “one or more of A and/or B”, or the like, may include all possible combinations of items enumerated together. For example, “A or B”, “at least one of A and B” or “at least one of A or B” may indicate all of 1) a case where at least one A is included, 2) a case where at least one B is included, or 3) a case where both of at least one A and at least one B are included.

Expressions “first”, “second”, and the like, used in the disclosure, may indicate various components regardless of the sequence and/or importance of the components. These expressions are used only to distinguish one component and another component from each other, and do not limit the corresponding components.

If any component (for example, a first component) is mentioned to be “(operatively or communicatively) coupled with/to” or “connected to” another component (for example, a second component), it should be understood that any component is directly coupled to another component or may be coupled to another component through still another component (for example, a third component).

If any component (for example, the first component) is mentioned to be “directly coupled” or “directly connected to” another component (for example, the second component), it should be understood that the other component (for example, the third component) is not present between any component and another component.

An expression “configured (or set) to” used in the disclosure may be replaced with an expression “suitable for”, “having the capacity to”, “designed to”, “adapted to”, “made to”, or “capable of” based on a context. The expression “configured (or set) to” may not necessarily indicate “specifically designed to” in hardware.

Rather, an expression “a device configured to” in some contexts may indicate that the device may “perform˜” together with another device or component. For example, “a processor configured (or set) to perform A, B and C” may indicate a dedicated processor (for example, an embedded processor) for performing the corresponding operations or a generic-purpose processor (for example, a central processing unit (CPU) or an application processor) that may perform the corresponding operations by executing one or more software programs stored in a memory device.

In embodiments, a “module” or a “˜er/or” may perform at least one function or operation, and be implemented in hardware or software, or be implemented by a combination of hardware and software. In addition, a plurality of “modules” or a plurality of “˜ers/ors” may be integrated with each other in at least one module and implemented by at least one processor except for a “module” or an “˜er/or” that is identified as needing to be implemented in specific hardware.

The various elements and regions in the drawings are schematically shown. Therefore, the disclosure is not limited by relative sizes or intervals shown in the accompanying drawings.

Hereinafter, embodiments of the disclosure are described in detail with reference to the accompanying drawings so that those skilled in the art to which the disclosure pertains may easily practice the embodiments.

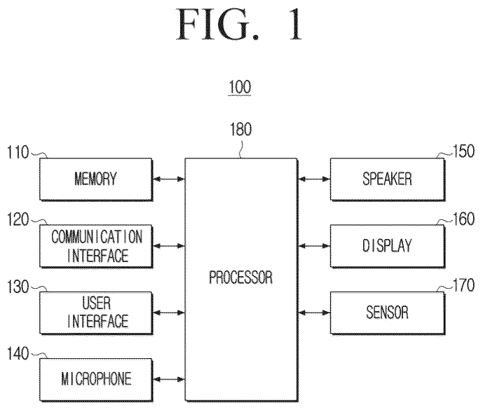

FIG. 1 is a block diagram for describing a configuration of an electronic apparatus according to an embodiment of the disclosure.

An electronic apparatus 100 may include memory 110, a communication interface 120, a user interface 130, a microphone 140, a speaker 150, a display 160, a sensor 170, and at least one processor 180 (hereafter “processor”). The electronic apparatus 100 may omit some of the above components, and may further include another component.

In addition, the electronic apparatus 100 may be implemented as an audio device such as earphones or a headset, which is only an embodiment, and may be implemented in any of various forms such as a smart phone, a tablet personal computer (PC), a PC, a server, a smart television (TV), a mobile phone, a personal digital assistant (PDA), a laptop, a media player, an e-book terminal, a digital broadcasting terminal, a navigation, a kiosk, an MP3 player, a digital camera, a wearable device, a home appliance, and another mobile or non-mobile computing device.

If the electronic apparatus 100 is implemented as a device other than the earphones or the headset, the electronic apparatus 100 may be connected to the earphones or the headset through the communication interface 120, perform communication with the earphones or headset, and may control the earphones or headset.

The memory 110 may store at least one instruction regarding the electronic apparatus 100. The memory 110 may store an operating system (O/S) for driving the electronic apparatus 100. In addition, the memory 110 may store various software programs or applications for operating the electronic apparatus 100 according to various embodiments of the disclosure. In addition, the memory 110 may include a semiconductor memory such as a flash memory, or a magnetic storing medium such as a hard disk.

In detail, the memory 110 may store various software modules for operating the electronic apparatus 100 according to the various embodiments of the disclosure, and the processor 180 may execute the various software modules stored in the memory 110 to control an operation of the electronic apparatus 100. That is, the memory 110 may be accessed by the processor 180, and the processor 180 may perform readout, recording, correction, deletion, update, and the like of data therein.

In the disclosure, the term “memory” may include the memory 110, a read only memory (ROM), or a random access memory (RAM) in the processor 180, and/or a memory card (for example, a micro secure digital (SD) card or a memory stick) mounted in the electronic apparatus 100.

The communication interface 120 may be a component including circuitry and communicating with an external device or the server. The communication interface 120 may communicate with the external device or the server by using wired or wireless communication methods. In this case, the communication interface 120 may include a Bluetooth module, a wireless-fidelity (Wi-Fi) module, an infrared (IR) module, a local area network (LAN) module, an Ethernet module, or the like. Each communication module may be implemented in the form of at least one hardware chip. In addition to the above-described communication methods, a wireless communication module may include at least one communication chip performing the communication based on various wireless communication standards such as zigbee, universal serial bus (USB), mobile industry processor interface camera serial interface (MIPI CSI), third generation (3G), 3rd generation partnership project (3GPP), long term evolution (LTE), LTE advanced (LTE-A), 4th generation (4G), and 5th generation (5G). However, this configuration is only an embodiment, and the communication interface 120 may use at least one communication module among various communication modules.

The user interface 130 may be a component for receiving a user command to control the electronic apparatus 100. The user interface 130 may be implemented as a device such as a button, a touch pad, a mouse, or a keyboard, or may be implemented as a touch screen capable of also performing a manipulation input function in addition to a display function. The button may be any of various types of buttons such as a mechanical button, a touch pad, or a wheel, which is disposed in any region, such as the front surface portion, side surface portion, or rear surface portion of a body appearance of the electronic apparatus 100. The electronic apparatus 100 may acquire various user inputs through the user interface 130.

The microphone 140 may be integrated with the electronic apparatus 100 in its upper, front, or side direction. The microphone 140 may include various components such as a microphone collecting a user voice in an analog form, an amplifier circuit amplifying the collected user voice, an analog to digital (A/D) conversion circuit sampling the amplified user voice and converting the same into a digital signal, a filter circuit canceling a noise component from the converted digital signal, and the like.

In addition, the microphone 140 may acquire audio data. The audio data may be data on audio surrounding the electronic apparatus 100. In addition, the audio surrounding the electronic apparatus 100 may include noise.

In addition, the microphone 140 may acquire a user voice input.

The speaker 150 may output an audio signal. For example, the speaker 150 may output the analog signal by converting the audio signal into a physical vibration signal that a user may perceive auditorily.

The speaker 150 may output a noise cancellation signal to cancel the noise included in the audio surrounding the electronic apparatus 100. That is, the speaker 150 may output the audio signal and the noise cancellation signal together.

The speaker 150 may output the noise cancellation signal at a different level for each of the plurality of noises. That is, the speaker 150 may output the plurality of noise cancellation signals at a different anti-noise level for each type of the plurality of noises.

The anti-noise level may indicate a noise cancellation level. In detail, the anti-noise level may indicate the magnitude, frequency, or power of the noise cancellation signal corresponding to an anti-phase signal of a noise signal. For example, the speaker 150 may completely cancel first noise by outputting the noise cancellation signal at a first level (e.g., 100%) for the first noise. In addition, the speaker 150 may cancel 50% of second noise by outputting the noise cancellation signal at a second level (e.g., 50%) for the second noise. In addition, the speaker 150 may not cancel third noise by outputting the noise cancellation signal at a third level (e.g., 0%) for the third noise. The third noise may be transmitted to the user through a hear-through mode or a pass-through mode without being canceled by the noise cancellation signal. The disclosure is not limited to the above example levels.

The display 160 may be implemented as a display including a self-light emitting element or a display including a non self-light emitting element and a backlight. For example, the display 160 may be implemented in any of various types of displays such as a liquid crystal display (LCD), an organic light emitting diode (OLED) display, a light emitting diode (LED) display, a micro light emitting diode (micro LED) display, a mini LED display, a plasma display panel (PDP), a quantum dot (QD) display, or a quantum dot light-emitting diode (QLED) display. The display 160 may also include a driving circuit, a backlight unit, and the like, which may be implemented in a form such as an a-si thin film transistor (TFT), a low temperature poly silicon (LTPS) TFT, or an organic TFT (OTFT).

The sensor 170 may detect the electronic apparatus 100 and a surrounding environment of the electronic apparatus 100. For example, the sensor 170 may include at least one of a global positioning system (GPS) sensor, a gesture sensor, a gyro sensor, a barometric sensor, a magnetic sensor, an acceleration sensor, a grip sensor, a proximity sensor, a color sensor, an infrared (IR) sensor, a temperature sensor, a humidity sensor, or an illuminance sensor. For example, the GPS sensor may acquire location information of a place where the audio data is acquired.

The processor 180 may control overall operations and functions of the electronic apparatus 100. In detail, the processor 180 may be connected to the configuration of the electronic apparatus that includes the memory 110, and executing at least one instruction stored in the memory 110 as described above, thereby controlling the overall operations of the electronic apparatus 100.

The processor 180 may be a single processor or a plurality of processors and be implemented in various ways. For example, the processor 180 may be implemented as at least one of an application specific integrated circuit (ASIC), an embedded processor, a microprocessor, hardware control logic, a hardware finite state machine (FSM), or a digital signal processor (DSP). In the disclosure, the term “processor” may be used to include a central processing unit (CPU), a graphic processing unit (GPU), a main processing unit (MPU), or the like.

An operation of the processor 180 for implementing the various embodiments of the disclosure may be implemented using a plurality of modules.

In detail, data for the plurality of modules according to the disclosure may be stored in the memory 110, and the processor 180 may access the memory 110 to load the data for the plurality of modules into the internal memory or buffer of the processor 180, and then use the plurality of modules, thereby implementing the various embodiments according to the disclosure.

However, at least one of the plurality of modules according to the disclosure may be implemented as hardware and included in the processor 180 in the form of a system on chip.

The processor 180 may acquire the audio data. The audio data may indicate data converted into the digital signal by receiving an analog audio source signal surrounding the electronic apparatus 100. In detail, the processor 180 may acquire the audio data of the audio surrounding the electronic apparatus 100 through the microphone 140. The audio surrounding the electronic apparatus 100 may include at least one noise. That is, the audio data may include the audio signal acquired from a plurality of audio sources. For example, the audio data may include vehicle noise, siren sound, impact sound, human conversation sound, or the like.

The processor 180 may acquire the audio data through the microphone 140, is not limited thereto, and may also acquire the audio data from the external device through the communication interface 120.

The processor 180 may acquire metadata of the audio data. The metadata of the audio data may include context information of the audio data. The context information of the audio data may indicate information regarding an environment where the audio is acquired.

In detail, the processor 180 may acquire the context information of the audio data through the sensor 170. In detail, the context information of the audio data may include at least one of an operation state of the electronic apparatus 100 (an active noise cancellation (ANC) mode or the hear-through mode) if the audio data is acquired, a user state (e.g., exercising) if the audio data is acquired, a location (e.g., latitude, longitude, or region) of the place where the audio data is acquired, a direction of the audio source, a weather of the place where the audio data is acquired, a temperature of the place where the audio data is acquired, or humidity of the place where the audio data is acquired.

The direction of the audio source may indicate a direction in which the audio source is disposed based on a specific direction in which the electronic apparatus 100 is oriented. For example, if the specific direction in which the electronic apparatus 100 is oriented is a front direction, information regarding a direction in which the audio data is generated may be the front direction of the electronic apparatus 100, a direction 90 degrees to the right from on the front of the electronic apparatus 100, or a rear direction based on the front of the electronic apparatus 100.

In detail, the sensor 170 may include the plurality of microphones 140. The processor 180 may identify the direction in which the audio signal is generated by comparing components of the audio signals input through the plurality of microphones 140. In detail, the processor 180 may use the plurality of microphone 140 to determine the direction in which the audio signal is output based on the electronic apparatus 100 (e.g., front, side, or rear of the electronic apparatus 100) on the basis of the audio components such as a time difference occurring as the same audio signal is input to each of the plurality of microphones 140, an amplitude difference in the audio signals, or a phase difference in the frequencies of the audio signals.

Alternatively, the processor 180 may acquire the location information of the place where the audio data is acquired through the GPS sensor.

The processor 180 may acquire the context information of the audio data through the sensor 170, which is only an embodiment, and the processor 180 may acquire the context information of the audio data from the external device including the sensor through the communication interface 120.

In addition, the processor 180 may classify the audio data into a plurality of audio clusters on the basis of at least one of a feature of the audio data or a feature of the metadata of the audio data.

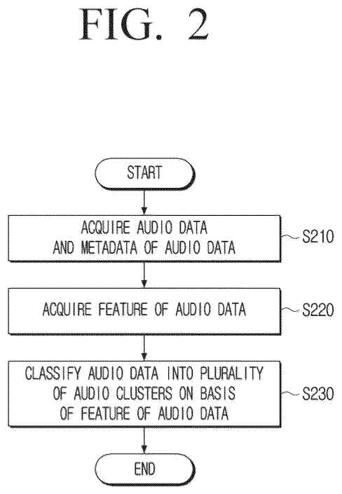

Referring to FIG. 2, the processor 180 may acquire the audio data and the metadata of the audio data (S210). In addition, the processor 180 may acquire the feature of the audio data (S220). The processor 180 may classify the audio data into the plurality of audio clusters on the basis of the feature of the audio data (S230).

In detail, the processor 180 may acquire a plurality of audio segments by segmenting the audio data into time or frequency units, and acquire the feature from the plurality of audio segments. In addition, the processor 180 may classify the plurality of audio segments into the plurality of audio clusters on the basis of information regarding similarity between the features acquired from the plurality of audio segments.

The acquired feature may be a feature of the audio signal such as its energy, mel frequency cepstral coefficient (MFCC), centroid, volume, power, sub-band energy, low short-time energy ratio, zero crossing rate, frequency centroid, frequency bandwidth, spectral flux, cepstral flux, or loudness.

Alternatively, the processor 180 may acquire feature information of the audio data that is acquired by coupling the feature of the audio signal included in the audio data with the feature included in the metadata of the audio data, and classify the plurality of audio data into the plurality of audio clusters based on the information regarding the similarity between the acquired feature information.

In addition, the acquired feature may have the form of an embedding feature vector (embedding vector). The processor 180 may classify the plurality of audio segments into the plurality of audio clusters on the basis of a distance between the feature vectors in an embedding space. That is, in the embedding space, the more similar a first feature vector and a second feature vector are, the closer the vectors may be disposed, and the more dissimilar the vectors are, the farther apart the vectors may be disposed. The processor 180 may classify the audio segments clustered within a threshold distance in the embedding space into one audio cluster.

Accordingly, the processor 180 may classify the audio data into the plurality of audio clusters based on a type of audio. For example, the processor 180 may classify the audio data into a first audio cluster, a second audio cluster, a third audio cluster, and a fourth audio cluster. The first audio cluster may be audio of the impact sound (e.g., vehicle crash sound). The second audio cluster may be audio of the siren. The third audio cluster may be audio of a sound generated from the front of the electronic apparatus. The fourth audio cluster may be audio of a sound generated from the rear of the electronic apparatus.

Alternatively, the first audio cluster may be audio of the impact sound generated in Seoul. The second audio cluster may be audio of the siren sound generated in Seoul. The third audio cluster may be audio of traffic noise occurring in Seoul.

In addition, the processor 180 may detect or identify whether each of the plurality of audio clusters is included in a plurality of pre-stored noise clusters (S320).

In detail, the memory 110 may include information regarding the plurality of noise clusters. The local database comprises the plurality of noise clusters. The local database may otherwise be referred to as noise database, local sound cluster database or local sound cluster database. The information regarding the plurality of noise clusters may include information regarding each noise, and the information regarding each noise may include at least one of identify information of the noise, a feature of the noise signal, metadata of the noise, and the anti-noise level corresponding to the noise.

The metadata of the noise may include at least one of tag information defining the noise, context information of the noise (e.g., location information or temperature information), data information of the noise being acquired, time information of the noise being acquired, or direction information of a noise source.

The context information of the noise may indicate the context information of a device that acquires the noise and surroundings of the device, if the noise is acquired.

The anti-noise level may indicate the noise cancellation level. In detail, the anti-noise level may indicate the magnitude, frequency, or power of the noise cancellation signal corresponding to anti-phase signal of the noise signal. For example, if the anti-noise level corresponding to the noise is 100%, the processor 180 may generate anti-noise data that may cancel the noise by 100%. Alternatively, if the anti-noise level corresponding to the noise is 50%, the processor 180 may generate the anti-noise data that may cancel the noise by 50%. Alternatively, if the anti-noise level corresponding to the noise is 0%, the processor 180 may not generate the anti-noise data that may cancel the noise.

The electronic apparatus 100 may use the generated anti-noise data to output an anti-noise signal through the speaker 150, which is only an embodiment, and the electronic apparatus 100 may transmit the anti-noise data to the external device (e.g., earphones) including the speakers, and control the external device to output the anti-noise signal.

In detail, the processor 180 may detect or identify whether each of the plurality of audio clusters is included in the plurality of noise clusters on the basis of a similarity value between the feature information of each of the plurality of audio clusters and feature information of each of the plurality of noise clusters.

In detail, the processor 180 may identify whether each of the plurality of audio clusters matches one of the plurality of pre-stored noise clusters. If a noise cluster matching the first audio cluster is not present, the processor 180 may identify the first audio cluster as not being included in the plurality of noise clusters. In addition, if the noise cluster matching the second audio cluster is present, the processor 180 may identify the second audio cluster as being included in the plurality of noise clusters.

The processor 180 may identify whether each of the plurality of audio clusters matches one of the plurality of noise clusters on the basis of the similarity value between each of the plurality of audio clusters and each of the plurality of noise clusters.

In detail, the processor 180 may acquire the similarity value between one of the plurality of audio clusters and one of the plurality of noise clusters. The processor 180 may identify one of the plurality of noise clusters as the noise cluster matching one of the plurality of audio clusters if the similarity value is a predetermined value or more.

That is, the processor 180 may identify the noise cluster having the similarity value of the predetermined value or more among the plurality of noise clusters, as the noise cluster matching one of the plurality of audio clusters.

If there are the plurality of noise clusters each having the similarity value greater than or equal to the predetermined value, the processor 180 may identify the noise cluster having the highest similarity value as the noise cluster matching one of the plurality of audio clusters.

Alternatively, the processor 180 may detect whether each of the plurality of audio clusters is included in the plurality of noise clusters by comparing the metadata of each of the plurality of audio clusters with the metadata of the plurality of noise clusters.

In detail, the processor 180 may compare the metadata of one of the plurality of audio clusters with the metadata of one of the plurality of noise clusters to identify whether the corresponding clusters match each other.

For example, the processor 180 may identify one of the plurality of audio clusters as matching one of the plurality of noise clusters if the metadata of one of the plurality of audio clusters matches the metadata of one of the plurality of noise clusters. The metadata may be at least one of the tag information, the context information of the place where the data is acquired, the date information of the data being acquired, the time information of the data being acquired, or the direction information of the data.

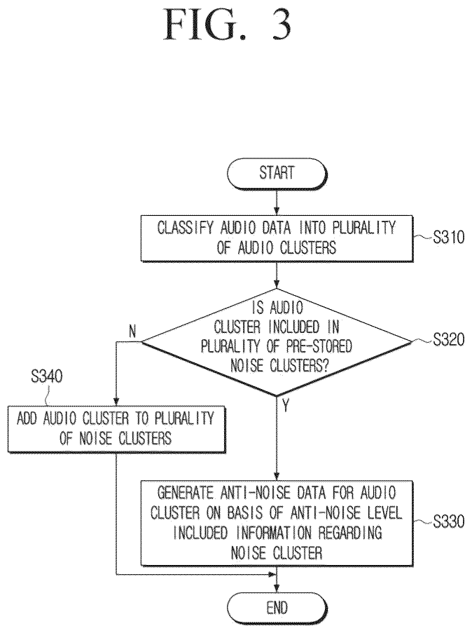

That is, referring to FIG. 3, the processor 180 may detect whether one of the plurality of audio clusters is included in the plurality of noise clusters (S320) if the audio data is classified into the plurality of audio clusters (S310).

The processor 180 may generate the anti-noise data for the audio cluster on the basis of the anti-noise level included information regarding the noise cluster matching the audio cluster (S330) if the audio cluster is included in the plurality of noise clusters (S320—Y). In addition, the processor 180 may output the anti-noise signal through the speaker 150 or transmit the same to the external device including the speaker, and control the external device to output the anti-noise signal, on the basis of the generated anti-noise data.

It may not be possible to cancel the noise not included in information regarding the noise cluster pre-stored in the memory 110 to an anti-noise level optimized for the user. That is, the noise may be the noise that requires the cancellation, the noise that does not require the cancellation, or the noise that requires the cancellation to a certain level, depending on a type of noise. However, it is impossible for the processor 180 to cancel the noise not included in the pre-stored noise cluster to the anti-noise level optimized for the user.

Accordingly, the electronic apparatus 100 of the disclosure may update the information regarding the noise cluster pre-stored in the memory 110 by using information regarding the audio cluster, which is not included in the plurality of noise clusters, and provide the user with the optimized acoustic noise cancellation (ANC) environment.

Therefore, the processor 180 may add the information regarding the audio cluster, which is not included in the plurality of noise clusters, to the information regarding the plurality of noise clusters (S340) if the audio cluster is not included in the plurality of noise clusters (S320—N). That is, the processor 180 may add the information regarding the audio cluster, which is not included in the plurality of pre-stored noise clusters, among the plurality of audio clusters to the information regarding the plurality of noise clusters.

According to an embodiment of the disclosure, the electronic apparatus 100 may update the information regarding the plurality of noise clusters stored in the memory 110 by using information acquired from the external server.

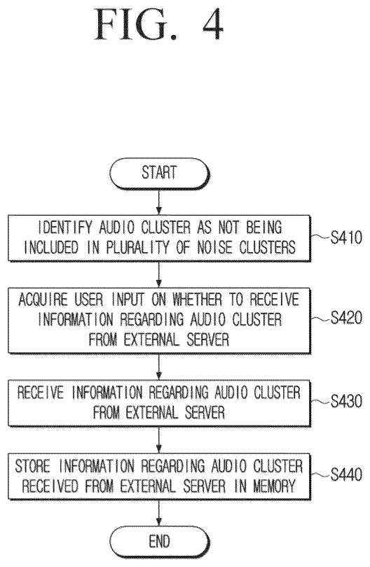

In detail, referring to FIG. 4, the processor 180 may acquire the user input on whether to receive the information regarding the audio cluster, which is not included in the plurality of noise clusters, from the external server (S420) if one of the plurality of audio clusters is identified as not being included in the plurality of noise clusters (S410).

In detail, the processor 180 may output information inquiring whether to receive the information regarding the audio cluster, which is not included in the plurality of noise clusters, from the external server. For example, the processor 180 may output a voice inquiring whether to receive the information regarding the audio cluster, which is not included in the plurality of noise clusters, from the external server through the speaker 150, or display a screen inquiring whether to receive the information regarding the audio cluster, which is not included in the plurality of noise clusters, from the external server through the display 160.

In addition, the processor 180 may receive the information regarding the audio cluster from the external server if the user input for receiving the information regarding the audio cluster, which is not included in the plurality of noise clusters, from the external server is acquired (S430).

The information regarding the audio cluster received from the external server may include the feature information of the audio cluster, the metadata of the audio cluster, and the anti-noise level corresponding to the audio cluster.

In addition, the processor 180 may store the information regarding the audio cluster received from the external server in the memory 110 (S440) to update the information regarding the plurality of noise clusters stored in the memory 110. That is, the processor 180 may add the information regarding the audio cluster, which is not included in the plurality of noise clusters, to the information regarding the plurality of noise clusters.

According to an embodiment of the disclosure, the electronic apparatus 100 may update the information regarding the plurality of noise clusters stored in the memory 110 on the basis of the user feedback.

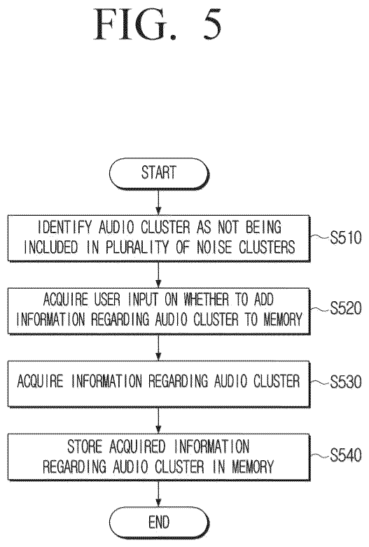

In detail, referring to FIG. 5, the processor 180 may output information inquiring whether to add the audio cluster to the plurality of noise clusters if the audio cluster is identified as not being included in the plurality of noise clusters (S510).

In detail, the processor 180 may output a voice inquiring whether to add the audio cluster to the plurality of noise clusters through the speaker 150, or display a screen inquiring whether to add the audio cluster to the plurality of noise clusters through the display 160.

In addition, the processor 180 may acquire the user input on whether to add the information regarding the audio cluster, which is not included in the plurality of noise clusters, to the memory 110 (S520).

For example, the processor 180 may output audio through the speaker 150 such as “Would you like to add information about current noise surrounding the electronic apparatus?”. In addition, the processor 180 may acquire the user voice input, such as “yes”, through the microphone 140.

In addition, the processor 180 may output the information inquiring the information regarding the audio cluster, which is not included in the plurality of noise clusters, if the user input for adding the information regarding the audio cluster to the memory 110 is acquired.

In detail, the processor 180 may output a voice inquiring for the information regarding the audio cluster, which is not included in the plurality of noise clusters, through the speaker 150, or display a screen inquiring for the information regarding the audio cluster, which is not included in the plurality of noise clusters, through the display 160.

In addition, the processor 180 may acquire the information regarding the audio cluster from the user input (S530). The information regarding the audio cluster acquired from the user input may include the metadata of the audio cluster, such as the tag information defining the audio cluster, and the anti-noise level corresponding to the audio cluster.

For example, the processor 180 may output audio through the speaker 150 inquiring the tag information for the audio, such as “What would you like to tag the current audio as?”. In addition, the processor 180 may acquire the user voice input, such as “office noise”, through the microphone 140.

In addition, the processor 180 may output audio such as “What is the anti-noise level of the current audio?”. In addition, the processor 180 may acquire the user voice input such as “100%”, “50%”, or “0%”.

In addition, the processor 180 may store the information regarding the audio cluster in the memory 110 on the basis of the acquired user input (S540), and add the same to the information regarding the plurality of noise clusters stored in the memory 110. The information added to the information regarding the plurality of noise clusters may include the feature information of the audio cluster, the metadata of the audio cluster, and the anti-noise level corresponding to the audio cluster.

The processor 180 may update the information regarding the plurality of noise clusters stored in the external server. That is, the processor 180 may transmit the acquired information regarding the audio cluster to the external server to update the information regarding the plurality of noise clusters stored in the external server.

For example, the external server may not store noise information regarding the office noise. The electronic apparatus 100 may transmit the acquired feature information of the office noise, the metadata of the office noise, or an anti-noise level corresponding to the office noise to the external server, thereby updating the information regarding the plurality of noise clusters stored in the external server.

Alternatively, the external server may not store the noise information acquired in New York. The electronic apparatus 100 may acquire information regarding the noise acquired in New York, transmit the acquired information to the external server to update the information regarding the plurality of noise clusters stored in the external server.

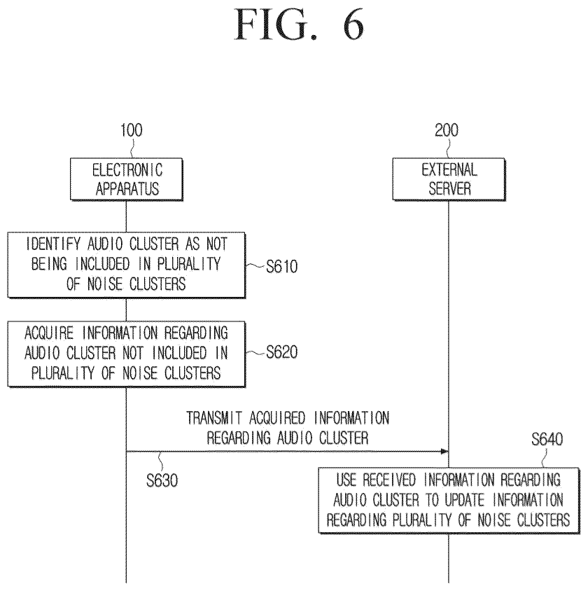

In detail, referring to FIG. 6, the electronic apparatus 100 may identify the audio cluster as not being included in the plurality of pre-stored noise clusters in the memory 110 or an external server 200 (S610).

The electronic apparatus 100 may acquire the information regarding the audio cluster not included in the plurality of noise clusters through the communication interface 120, the user interface 130, or the microphone 140 (S620). The electronic apparatus 100 may transmit the acquired information regarding the audio cluster to the external server 200 if the information regarding the audio cluster not included in the plurality of noise clusters is acquired (S630).

Accordingly, the external server 200 may store the received information regarding the audio cluster in the memory of the external server 200 to update the information regarding the plurality of noise clusters stored in the memory of the external server 200 (S640).

That is, the electronic apparatus 100 may transmit the acquired information regarding the audio cluster to the external server 200, and control the external server 200 to update the information regarding the plurality of noise clusters.

Even if the type of noise is the same, the information regarding the noise cluster may need to be stored differently depending on the user. For example, even if information regarding a specific noise such as “the office noise” is stored in the memory 110, the feature information of the specific noise may be different depending on the user. That is, the office noise of a first user and the office noise of a second user may be different from each other. The information regarding an office noise cluster stored in the memory 110 may be optimized for the office noise of the first user, and may not be optimized for the office noise of the second user.

The external server 200 may store the information regarding the plurality of audio clusters differently for respective user accounts of the electronic apparatus 100, and the electronic apparatus 100 may update the information regarding the plurality of noise clusters corresponding to the user account. Accordingly, the user of the electronic apparatus 100 may use the same ANC environment through the external device by using the information regarding the plurality of noise clusters pre-stored in the user account.

According to an embodiment of the disclosure, the electronic apparatus 100 may update the information regarding the plurality of noise clusters by using the information regarding the audio cluster included in the plurality of noise clusters.

That is, even if the audio cluster is included in the plurality of noise clusters, the processor 180 may use the information regarding the audio cluster to update the information regarding the plurality of noise clusters.

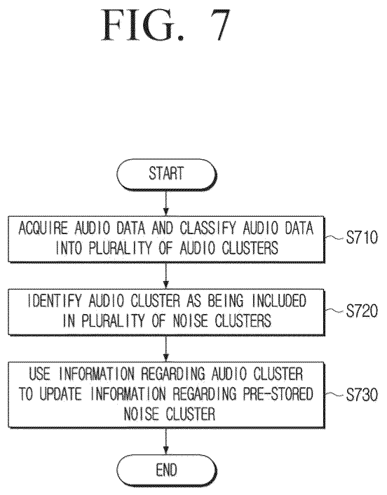

In detail, referring to FIG. 7, the processor 180 may acquire the audio data and classify the audio data into the plurality of audio clusters (S710).

In addition, the processor 180 may identify one of the plurality of audio clusters as being included in the plurality of noise clusters (S720).

For example, the acquired audio cluster may be the “office noise” cluster, and one of the plurality of noise clusters may be the “office noise” cluster.

The processor 180 may use the information regarding the audio cluster to update information included in the pre-stored noise cluster (S730). The information regarding the audio cluster may include the feature information of the audio cluster, the metadata of the audio cluster, or the anti-noise level corresponding to the audio cluster.

For example, the processor 180 may use the feature information of the audio cluster “the office noise” to update the pre-stored information regarding the noise cluster “the office noise”. That is, the processor 180 may replace the feature information included in the pre-stored noise cluster “the office noise” with the feature information of the audio cluster “the office noise”. Alternatively, the processor 180 may add the feature information regarding the audio cluster “the office noise” to the feature information included in the pre-stored noise cluster “the office noise”.

Alternatively, the processor 180 may acquire the information regarding the audio cluster “the office noise” through the communication interface 120, the user interface 130, or the microphone 140. The information regarding the audio cluster “the office noise” may include the anti-noise level of the audio cluster “the office noise”.

Accordingly, the processor 180 may replace the anti-noise level included in the information regarding the noise cluster “the office noise” with the anti-noise level of the audio cluster “the office noise”.

In detail, the processor 180 may add the acquired audio feature of the office noise cluster to the audio feature of the pre-stored office noise cluster. Alternatively, the processor 180 may replace the audio feature of the pre-stored office noise cluster with the acquired audio feature of the office noise cluster.

As described above, the electronic apparatus 100 according to the disclosure may provide the optimized ANC environment to the user by updating the information regarding the plurality of noise clusters even if the acquired audio cluster is included in the plurality of pre-stored noise clusters in the memory 110.

The processor 180 according to an embodiment of the disclosure may update the information regarding the noise cluster stored in the memory 110 based on a predetermined update cycle. Alternatively, the processor 180 may update the information regarding the noise cluster stored in the memory 110 if the user input for updating the information regarding the noise cluster stored in the memory 110 is acquired.

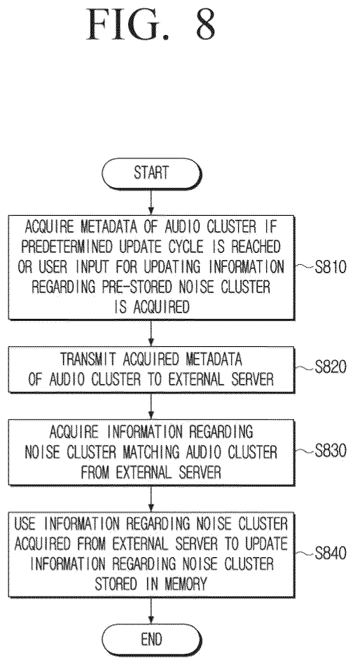

In detail, referring to FIG. 8, the processor 180 may acquire the metadata of the audio cluster if the predetermined update cycle is reached or the user input for updating the information regarding the pre-stored noise cluster is acquired (S810).

In addition, the processor 180 may transmit the acquired metadata of the audio cluster to the external server (S820). If the metadata of the audio cluster is received, the external server may acquire feature data of the metadata, and compare the same with feature data of the noise cluster stored in the external server to identify whether the information regarding the noise cluster matching the audio cluster is stored in the memory of the external server.

Accordingly, the processor 180 may acquire the information regarding the noise cluster matching the audio cluster from the external server if the information regarding the noise cluster matching the audio cluster is identified as being stored in the memory of the external server (S830). The acquired information regarding the noise cluster may include the feature information of the noise cluster, the metadata of the noise cluster, or the anti-noise level corresponding to the noise cluster. The metadata included in the acquired information regarding the noise cluster may indicate the tag information defining the noise cluster.

In addition, the processor 180 may use the information regarding the noise cluster acquired from the external server to update the information regarding the noise cluster stored in the memory 110 (S840).

According to an embodiment of the disclosure, the electronic apparatus 100 may transmit the acquired audio data and the context information of the audio data to the external server to update the information regarding the noise cluster stored in the external server.

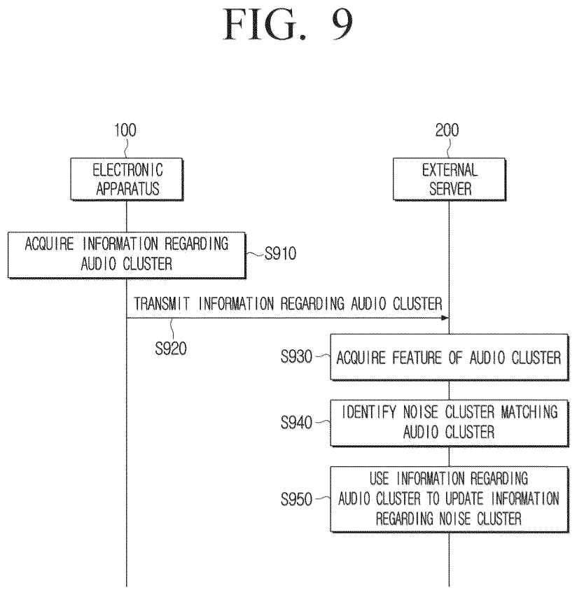

In detail, referring to FIG. 9, the electronic apparatus 100 may acquire the audio cluster and the metadata of the audio cluster (S910).

In addition, the electronic apparatus 100 may transmit the information regarding the audio cluster to the external server 200 (S920). The information regarding the audio cluster may include the metadata of the audio cluster.

In addition, the external server 200 may acquire the feature information of the audio cluster (S930). The feature information of the audio cluster may be the feature information coupled with the feature of the audio signal included in the audio cluster and the feature included in the metadata of the audio cluster.

In addition, the external server 200 may identify whether the noise cluster matching the audio cluster is stored in the memory of the external server 200 by comparing the feature of the audio cluster with the feature information of the noise cluster stored in the memory of the external server 200. That is, the external server 200 may detect whether the audio cluster is included in the plurality of noise clusters stored in the memory of the external server 200.

The external server 200 may determine whether the feature of the audio cluster and the feature of the noise cluster are present within the threshold distance in the embedding space, and identify the noise cluster disposed within the threshold distance as the noise cluster matching the audio cluster.

If the noise cluster matching the audio cluster is identified (S940), the external server 200 may update the information regarding the noise cluster stored in the memory of the external server 200 by merging or segmenting the information regarding the audio cluster with or into the information regarding the noise cluster stored in the memory of the external server 200 (S950).

If the noise cluster matching the audio cluster is not identified, the external server 200 may define the audio cluster as a new noise cluster and add information regarding the new noise cluster to the information regarding the noise cluster stored in the memory of the external serve.

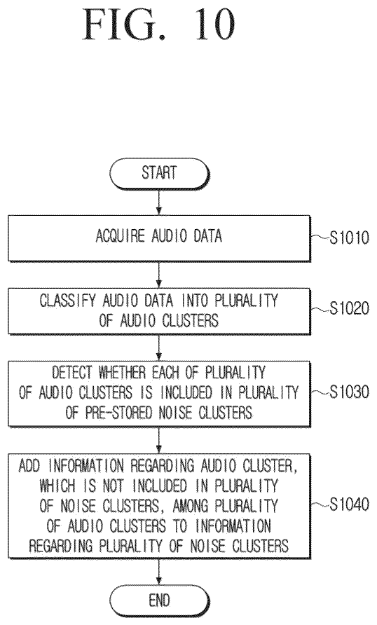

FIG. 10 is a flowchart for describing a control method of an electronic apparatus 100 according to an embodiment of the disclosure.

The electronic apparatus 100 may acquire the audio data (S1010).

In addition, the electronic apparatus 100 may classify the audio data into the plurality of audio clusters (S1020).

In addition, the electronic apparatus 100 may detect whether each of the plurality of audio clusters is included in the plurality of pre-stored noise clusters (S1030).

In addition, the electronic apparatus 100 may add the information regarding the audio cluster, which is not included in the plurality of noise clusters, among the plurality of audio clusters to the information regarding the plurality of noise clusters (S1040).

According to an embodiment of the disclosure, the electronic apparatus 100 may obtain audio data and metadata of the audio data. The electronic apparatus 100 may classify the audio data into a plurality of audio clusters based on at least one of a feature of the audio data or a feature of the metadata.

The electronic apparatus 100 may identify whether each audio cluster of the plurality of audio clusters is included in a local database corresponding to the location information of a place where the audio data is obtained. The local database comprises a plurality of noise clusters. The electronic apparatus 100 may identify one audio cluster of the plurality of audio clusters as being included in the local database based on one noise cluster matching the one audio cluster being present among the plurality of noise clusters

Based on the at least one of the plurality of the audio clusters being not included in the local database, the electronic apparatus 100 may update the local database by adding information regarding the audio cluster that is not included in the local database. The electronic apparatus 100 may obtain, from an external server, the information regarding the audio cluster that is not included in the local database.

The electronic apparatus 100 may obtain a user input for inputting identification information for the audio cluster that is not included in the local database. The electronic apparatus 100 may provide a sound inquiring whether to add the information regarding the audio cluster to the information regarding the local database. Based on obtaining a user voice for adding the information regarding the audio cluster to the information regarding the local database, the electronic apparatus 100 may obtain the user input for inputting the identification information for the audio cluster that is not included in the local database.

Then, the electronic apparatus 100 may add the information regarding the audio cluster that is not included in the local database to the information regarding the local database.

The electronic apparatus 100 may generate anti-noise data based on the information regarding the local database which is updated.

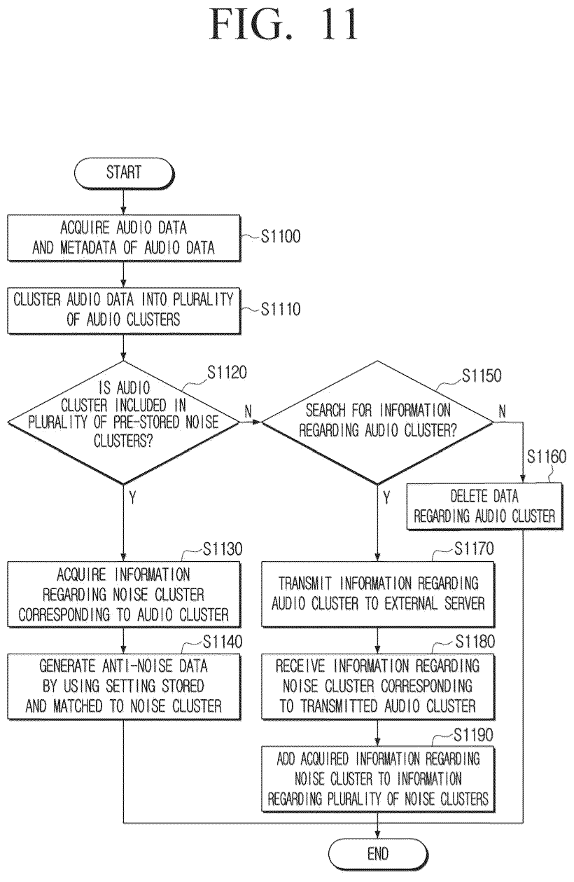

FIG. 11 is a diagram for describing an operation of the electronic apparatus 100 according to an embodiment of the disclosure.

The processor 180 may acquire the audio data and the metadata of the audio data (S1100). The metadata of the audio data may include the location information of the audio data being acquired.

In addition, the processor 180 may classify the audio data into the plurality of audio clusters based on the feature of the audio data and the feature included in the metadata of the audio data (S1110). For example, the processor 180 may classify the audio data into the first audio cluster and the second audio cluster. The first audio cluster may be the audio of the impact sound acquired in New York, and the second audio cluster may be the siren sound acquired in New York.

In addition, the processor 180 may identify whether each of the plurality of audio clusters is included in the noise cluster stored in the memory (S1120).

The processor 180 may acquire the information regarding the noise cluster corresponding to the audio cluster (S1130) if the audio cluster is identified as being included in the plurality of noise clusters (S1120—Y). For example, the memory may store information regarding an impact sound cluster acquired in New York.

In addition, the processor 180 may generate the anti-noise data for the audio cluster by using a setting stored and matched to the noise cluster (S1140).

The processor 180 may identify whether to search the external server for the information regarding the audio cluster (S1150) if the audio cluster is identified as not being included in the plurality of noise clusters (S1120—N).

The processor 180 may provide the user with information inquiring whether to search the external server for the information regarding the audio cluster. In addition, the processor 180 may identify whether to search the external server for the information regarding the audio cluster on the basis of the user input on whether to search for the information regarding the audio cluster.

In detail, the processor 180 may provide the user with information inquiring whether to search the external server for the information regarding the audio cluster. The processor 180 may control the speaker 150 to output a voice inquiring whether to search the external server for the information regarding the audio cluster. Alternatively, the processor 180 may control the display 160 to display a screen including a text inquiring whether to search the external server for the information regarding the audio cluster. Alternatively, the processor 180 may transmit a control signal to a user terminal device to display the information inquiring whether to search the external server for the information regarding the audio cluster.

For example, the processor 180 may control the speaker 150 to output a voice such as “Would you like to search the external server for information regarding the currently acquired audio cluster?” or “Would you like to search the cloud for the information regarding the currently acquired audio cluster?”.

Alternatively, the processor 180 may provide, through the display 160, a user interface (UI) including a text such as “Would you like to search the external server for information regarding the currently acquired audio cluster?” or “Would you like to search the cloud for the information regarding the currently acquired audio cluster?”.

Alternatively, the processor 180 may transmit, to the user terminal device, a control signal for displaying the UI including the text such as “Would you like to search the external server for information regarding the currently acquired audio cluster?” or “Would you like to search the cloud for the information regarding the currently acquired audio cluster?”.

In addition, the processor 180 may acquire the user input on whether to add the audio cluster to the noise cluster through the communication interface 120, the user interface 130, or the microphone 140.

The processor 180 may delete data regarding the audio cluster from the memory (S1160) if the user input for not searching for the information regarding the audio cluster is acquired (S1150—N).

In addition, the processor 180 may transmit the information regarding the audio cluster to the external server (S1170) if the user input for searching for the information regarding the audio cluster is acquired (S1150—Y). The information regarding the audio cluster may include at least one of the feature of the audio data, the metadata of the audio data, and a tag of the audio data.

In addition, the processor 180 may receive information corresponding to the noise cluster corresponding to the transmitted audio cluster (S1180). The information corresponding to the noise cluster may include at least one of the feature, metadata, tag information, or anti-noise level of the noise cluster.

In addition, the processor 180 may add the acquired information regarding the noise cluster to the information regarding the plurality of noise clusters stored in the memory (S1190). Accordingly, the processor 180 may generate the anti-noise data for the audio cluster at a noise level corresponding to the acquired noise cluster.

That is, according to an embodiment of the disclosure, even if the environment (e.g., location) is changed, the user of the electronic apparatus 100 may update the information regarding the plurality of noise clusters stored in the memory to optimize the same to the changed environment (e.g., from Seoul to New York) by using the information received from the external server. In addition, the user of the electronic apparatus 100 may experience a noise cancellation environment optimized for the user even in the changed environment.

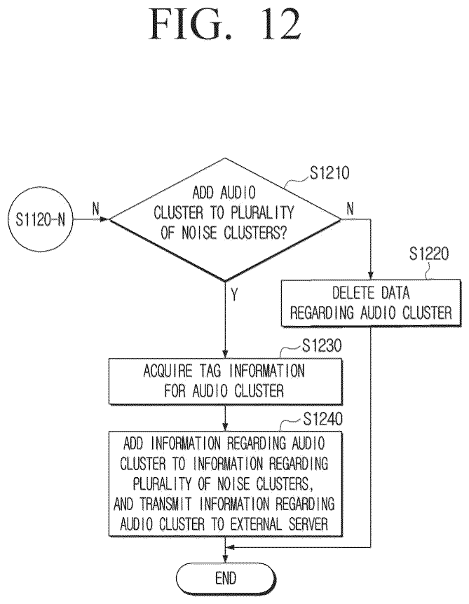

FIG. 12 is a diagram for describing an operation of the electronic apparatus according to an embodiment of the disclosure.

Referring to FIG. 12, the processor 180 may acquire the user input on whether to add the audio cluster to the plurality of noise clusters if the audio cluster is identified as not being included in the plurality of pre-stored noise clusters (S1120—N).

In detail, the processor 180 may provide the user with the information inquiring whether to add the audio cluster to the plurality of noise clusters. In detail, the processor 180 may control the speaker 150 to output the voice inquiring whether to add the audio cluster to the plurality of noise clusters. Alternatively, the processor 180 may control the display 160 to display the screen including a text inquiring whether to add the audio cluster to the plurality of noise clusters.

For example, the processor 180 may control the speaker 150 to output a voice such as “Would you like to add the currently acquired audio cluster to the noise cluster?” or “Would you like to add the currently acquired audio cluster to the cloud?”.

Alternatively, the processor 180 may provide, through the display 160, a UI including a text such as “Would you like to add the currently acquired audio cluster to the noise cluster?” or “Would you like to add the currently acquired audio cluster to the cloud?”.

Alternatively, the processor 180 may transmit, to the user terminal device, information for displaying a UI including the text such as “Would you like to add the currently acquired audio cluster to the noise cluster?” or “Would you like to add the currently acquired audio cluster to the cloud?”.

In addition, the processor 180 may acquire the user input on whether to add the audio cluster to the noise cluster through the communication interface 120, the user interface 130, or the microphone 140.

The processor 180 may delete the information regarding the audio cluster stored in the memory (S1220) if the user input for not adding the audio cluster to the plurality of noise clusters is acquired (S1210—N).

The processor 180 may acquire the tag information for the audio cluster (S1230) if the user input for adding the audio cluster to the plurality of noise clusters is acquired (S1210—Y).

In detail, the processor 180 may acquire the tag information for the audio cluster through the communication interface 120, the user interface 130, or the microphone 140. The tag may be text information that defines the audio cluster. In detail, the tag of the audio data may be text information that defines a type of the audio cluster. For example, the tag of the audio data may be “the office noise”, “the siren sound”, “music sound”, “lecture sound”, “sound heard in front of the electronic apparatus 100”, “sound heard from the side of the electronic apparatus”, “sound heard from the rear of the electronic apparatus 100”, or the like.

The processor 180 may provide the user with information inquiring a tag for the audio cluster to acquire the tag information for the audio cluster. In detail, the processor 180 may output a voice inquiring the tag for the audio cluster through the speaker 150. Alternatively, the processor 180 may display, through the display 160, a screen that includes a text inquiring the tag for the audio cluster.

For example, the processor 180 may output, through the speaker 150, a voice such as “Please define the audio currently acquired”, “What is the type of audio currently acquired?”, or “Please enter the tag for the currently acquired audio cluster”.

Alternatively, the processor 180 may provide, through the display 160, a UI including a text such as “Please define the audio currently acquired”, “What is the type of audio currently acquired?”, or “Please input the tag for the currently acquired audio cluster”.

The processor 180 may acquire, through the microphone 140, the user voice input for inputting the tag for the audio cluster.

Alternatively, the processor 180 may acquire the user input for inputting the tag for the audio cluster through the user interface 130. The processor 180 may acquire the user input for inputting the tag for the audio cluster through the UI provided through the display 160.

Alternatively, the processor 180 may acquire information on the tag for the audio cluster through the communication interface 120.

In addition, the processor 180 may acquire the user input for setting the anti-noise level of the audio cluster. The processor 180 may provide the user with information inquiring the anti-noise level of the audio cluster to acquire the anti-noise level of the audio cluster. In detail, the processor 180 may output a voice inquiring the anti-noise level of the audio cluster through the speaker 150. Alternatively, the processor 180 may display, through the display 160, a screen including a text inquiring the anti-noise level of the audio cluster.

In addition, the processor 180 may add the information regarding the audio cluster to the information regarding the plurality of noise clusters stored in the memory, and transmit the information regarding the audio cluster to the external server 200.

Accordingly, the external server 200 may use the received information regarding the audio cluster to update the information regarding the plurality of noise clusters stored in the external server 200.

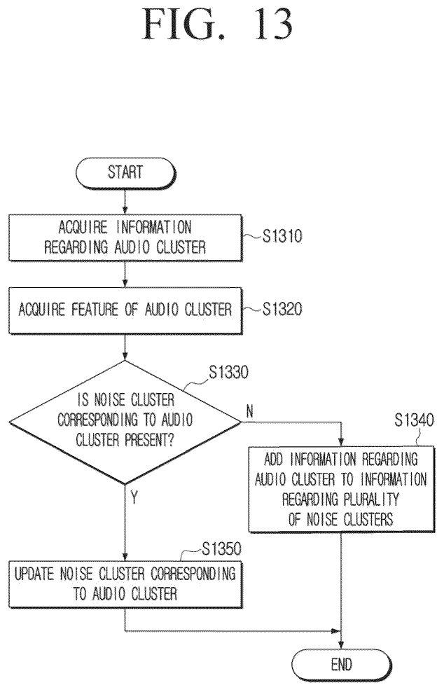

FIG. 13 is a flowchart for describing a method of the server for updating the information regarding the noise cluster according to an embodiment of the disclosure.

The server z may acquire the information regarding the audio cluster from the electronic apparatus 100 (S1310). The information regarding the audio cluster acquired from the electronic apparatus 100 may include at least one of the feature, metadata, or tag information of the audio signal.

In addition, the server 200 may acquire the feature of the audio cluster on the basis of the acquired information regarding the audio cluster (S1320). In detail, the server 200 may acquire the feature of the tag information regarding at least one of the feature of the audio signal, the feature of the metadata, or a feature of the tag information, and acquire its feature vector.

In addition, the server 200 may identify whether the noise cluster corresponding to the audio cluster acquired from the information regarding the plurality of noise clusters stored in the server 200 is present (S1330). That is, the server 200 may identify whether the acquired information regarding the noise cluster matching the audio cluster is stored in the server 200.

Accordingly, the server 200 may add the acquired information regarding the audio cluster to the information regarding the plurality of noise clusters (S1340) if the noise cluster corresponding to the audio cluster is not present (S1330—N).

Accordingly, the server 200 may continuously update the information regarding the noise cluster stored in the server 200 by using the information regarding the audio cluster acquired from the user.

The server 200 may store the information regarding the plurality of noise clusters for the user account of the electronic apparatus 100. Accordingly, the information regarding the plurality of noise clusters corresponding to the user account and stored in the server 200 may be continuously updated to be optimized for the user.

In addition, the server 200 may update the noise cluster corresponding to the audio cluster if the noise cluster corresponding to the audio cluster is present (S1330—Y). That is, the server 200 may merge the acquired information of the audio cluster with the information regarding the noise cluster corresponding to the audio cluster. Alternatively, the server 200 may segment the acquired information regarding the noise cluster and the information regarding the noise cluster corresponding to the audio cluster from each other and store the same in the memory of the server 200.

The term “˜er/˜or” or “module” used in the disclosure may include a unit including hardware, software, or firmware, and may be used interchangeably with the term, for example, logic, a logic block, a component, or a circuit. The “˜er/˜or” or “module” may be an integrally formed component, or a minimum unit or part performing one or more functions. For example, the module may include an application-specific integrated circuit (ASIC).

The various embodiments of the disclosure may be implemented as software including an instruction stored on a machine-readable storage medium (for example, a computer-readable storage medium). A machine may be a device that invokes the stored instruction from the storage medium, may be operated based on the invoked instruction, and may include the electronic apparatus 100 in the disclosed embodiments. If the instruction is executed by the processor, the processor may directly perform a function corresponding to the instruction or other components may perform the function corresponding to the instruction under the control of the processor. The instruction may include codes generated or executed by a compiler or an interpreter. The machine-readable storage medium may be provided in the form of a non-transitory storage medium. The term “non-transitory” indicates that the storage medium is tangible without including a signal, and does not distinguish whether data are semi-permanently or temporarily stored in the storage medium.

According to an embodiment, the method according to the various embodiments disclosed in this document may be provided by being included in a computer program product. The computer program product may be traded as a product between a seller and a purchaser. The computer program product may be distributed in a form of the machine-readable storage medium (for example, a compact disc read only memory (CD-ROM)), or may be distributed online through an application store (for example, PlayStore™). In case of the online distribution, at least a part of the computer program product may be at least temporarily stored or temporarily provided in a storage medium such as a memory of a server of a manufacturer, a server of an application store, or a relay server.

Each of the components (for example, modules or programs) according to the various embodiments may include one entity or a plurality of entities, and some of the corresponding sub-components described above may be omitted or other sub-components may be further included in the various embodiments. Alternatively or additionally, some of the components (e.g., modules or programs) may be integrated into one entity, and may perform functions performed by the respective corresponding components before being integrated in the same or similar manner. Operations performed by the modules, the programs, or other components according to the various embodiments may be executed in a sequential manner, a parallel manner, an iterative manner or a heuristic manner, at least some of the operations may be performed in a different order or be omitted, or other operations may be added.

What is claimed is:

1. A control method of an electronic apparatus for generating anti-noise for acoustic noise cancellation (ANC), the control method comprising:
obtaining audio data and metadata of the audio data;
classifying the audio data into a plurality of audio clusters based on at least one of a feature of the audio data or a feature of the metadata;
identifying whether each audio cluster of the plurality of audio clusters is included in a local database corresponding to the location information of a place where the audio data is obtained;
based on the at least one of the plurality of the audio clusters being not included in the local database, updating the local database by adding information regarding the audio cluster that is not included in the local database, and
generating anti-noise data based on the information regarding the local database which is updated.

2. The control method as claimed in claim 1, wherein the local database comprises a plurality of noise clusters, and
wherein the identifying whether each audio cluster of the plurality of audio clusters is included in the local database comprises:
identifying one audio cluster of the plurality of audio clusters as being included in the local database based on one noise cluster matching the one audio cluster being present among the plurality of noise clusters.

3. The control method as claimed in claim 2, wherein the identifying whether each of the plurality of audio clusters is included in the local database comprises:
obtaining a similarity value between the one audio cluster and the one noise cluster; and
identifying the one noise cluster of the plurality of noise clusters as the one noise cluster matching the one audio cluster based on the similarity value being at least a predetermined value.

4. The control method as claimed in claim 1, wherein the updating the local database by adding the information regarding the audio cluster comprises:
obtaining, from an external server, the information regarding the audio cluster that is not included in the local database; and
adding the information regarding the audio cluster that is not included in the local database to the information regarding the local database.

5. The control method as claimed in claim 1, wherein the updating the local database by adding the information regarding the audio cluster comprises:
obtaining a user input for inputting identification information for the audio cluster that is not included in the local database; and
adding the information regarding the audio cluster including the identification information to the information regarding the local database.

6. The control method as claimed in claim 5, wherein the updating the local database by adding the information regarding the audio cluster comprises:
providing a sound inquiring whether to add the information regarding the audio cluster to the information regarding the local database; and
based on obtaining a user voice for adding the information regarding the audio cluster to the information regarding the local database, obtaining the user input for inputting the identification information for the audio cluster that is not included in the local database.

7. The control method as claimed in claim 1, wherein the generating the anti-noise data comprises, generating the anti-noise data at a level corresponding to a noise cluster matching the audio cluster for each audio cluster of the plurality of audio clusters included in the local database among the plurality of audio clusters.

8. The control method as claimed in claim 7, wherein the plurality of audio clusters include a first audio cluster and a second audio cluster, and
wherein the generating the anti-noise data comprises:
generating first anti-noise data for the first audio cluster at a first level corresponding to a first noise cluster matching the first audio cluster among the plurality of noise clusters; and
generating second anti-noise data for the second audio cluster at a second level corresponding to a second noise cluster matching the second audio cluster among the plurality of noise clusters.

9. The control method as claimed in claim 1, wherein the classifying of the audio data into the plurality of audio clusters comprises:
obtaining a plurality of audio segments by segmenting the audio data;
obtaining a plurality of feature data by extracting features of the plurality of audio segments; and
classifying the plurality of audio segments into a plurality of sound clusters based on the plurality of feature data.

10. The control method as claimed in claim 1, wherein the metadata of the audio data includes location information of a place where the audio data is obtained.

11. An electronic apparatus configured to generate anti-noise for acoustic noise cancellation (ANC), the apparatus comprising:
a sensor;
a microphone;
a speaker;
memory storing at least one instruction and information regarding a local database; and
at least one processor connected to the memory,
wherein the at least one instruction, when executed by the at least one processor, cause the electronic apparatus to:
obtain audio data and metadata of the audio data through the microphone and the sensor;
classify the audio data into a plurality of audio clusters based on at least one of a feature of the audio data or a feature of the metadata;
identify whether each audio cluster of the plurality of audio clusters is included in the local database corresponding to the location information of a place where the audio data is obtained;
based on the at least one of the plurality of the audio clusters being not included in the local database, update the local database by adding information regarding the audio cluster that is not included in the local database; and
generate anti-noise data based on the information regarding the local database which is updated.

12. The electronic apparatus as claimed in claim 11, wherein the local database comprises a plurality of noise clusters, and
wherein the at least one instruction, when executed by the at least one processor, cause the electronic apparatus to identify one audio cluster of the plurality of audio clusters as being included in the local database based on one noise cluster matching the one audio cluster being present among the plurality of noise clusters.

13. The electronic apparatus as claimed in claim 12, wherein the at least one instruction, when executed by the at least one processor, cause the electronic apparatus to:
obtain a similarity value between the one audio cluster and the one noise cluster; and
identify the one noise cluster as the one noise cluster matching the one audio cluster if the similarity value is a predetermined value or more.

14. The electronic apparatus as claimed in claim 11, wherein the at least one instruction, when executed by the at least one processor, cause the electronic apparatus to:
obtain, from an external server, the information regarding the audio cluster that is not included in the local database; and
add the information regarding the audio cluster that is not included in the local database to the information regarding the local database.

15. The electronic apparatus as claimed in claim 11, wherein the at least one instruction, when executed by the at least one processor, cause the electronic apparatus to:
obtain a user input for inputting identification information for the audio cluster that is not included in the local database, and
add the information regarding the audio cluster including the identification information to the information regarding the local database.

16. A non-transitory computer readable recording medium comprising instructions that, when executed, performs a method comprising:
obtaining audio data and metadata of the audio data;
classifying the audio data into a plurality of audio clusters based on at least one of a feature of the audio data or a feature of the metadata;
identifying whether each audio cluster of the plurality of audio clusters is included in a local database corresponding to the location information of a place where the audio data is obtained;
based on the at least one of the plurality of the audio clusters being not included in the local database, updating the local database by adding information regarding the audio cluster that is not included in the local database; and
generating anti-noise data based on the information regarding the local database which is updated.

17. The non-transitory computer readable recording medium of claim 16, wherein the local database comprises a plurality of noise clusters, and
wherein the identifying whether each audio cluster of the plurality of audio clusters is included in the local database comprises:
identifying one audio cluster of the plurality of audio clusters as being included in the local database based on one noise cluster matching the one audio cluster being present among the plurality of noise clusters.

18. The non-transitory computer readable recording medium of claim 17, wherein the identifying whether each of the plurality of audio clusters is included in the local database comprises:
obtaining a similarity value between the one audio cluster and the one noise cluster; and
identifying the one noise cluster of the plurality of noise clusters as the one noise cluster matching the one audio cluster based on the similarity value being at least a predetermined value.

19. The non-transitory computer readable recording medium of claim 16, wherein the updating the local database by adding the information regarding the audio cluster comprises:
obtaining, from an external server, the information regarding the audio cluster that is not included in the local database; and
adding the information regarding the audio cluster that is not included in the local database to the information regarding the local database.

20. The non-transitory computer readable recording medium of claim 16, wherein the updating the local database by adding the information regarding the audio cluster comprises:
obtaining a user input for inputting identification information for the audio cluster that is not included in the local database; and
adding the information regarding the audio cluster including the identification information to the information regarding the local database.
